(19) United States
(12) Patent Application Publication
(10) Pub. No.: US 2025/0372311 A1
(43) Pub. Date: Dec. 4, 2025

(54) MULTILAYER CERAMIC CAPACITOR

(71) Applicant: Murata Manufacturing Co., Ltd., Nagaokakyo-shi (JP)

(72) Inventor: Kentaro FUJIWARA, Nagaokakyo-shi (JP)

(21) Appl. No.: 19/298,502

(22) Filed: Aug. 13, 2025

Related U.S. Application Data
(63) Continuation of application No. PCT/JP2024/004131, filed on Feb. 7, 2024.

(30) Foreign Application Priority Data
Apr. 7, 2023 (JP) 2023-062812

(51) Int. Cl. H01G 4/30; H01G 4/232

(52) U.S. Cl. CPC H01G 4/30; H01G 4/2325

(57) ABSTRACT

A multilayer body includes a first surface and a second surface opposite each other in a lamination direction, a third surface and a fourth surface opposite each other in a first direction, and a fifth surface and a sixth surface opposite each other in a second direction orthogonal. An inner layer portion includes an inner dielectric layer and an inner electrode laminated on the inner dielectric layer in the lamination direction. The inner electrode includes an end portion at the fifth surface. An outer electrode on the fifth surface includes an inner base electrode layer on the inner layer portion at the fifth surface and connected to the inner electrode, an inner glass layer on the inner base electrode layer, a plating layer on the inner glass layer, and a connecting portion penetrating through the inner glass layer and electrically connecting the inner base electrode layer to the plating layer.

### CROSS REFERENCE TO RELATED APPLICATIONS

This application claims the benefit of priority to Japanese Patent Application No. 2023-062812 filed on Apr. 7, 2023 and is a Continuation application of PCT Application No. PCT/JP2024/004131 filed on Feb. 7, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

In recent years, improvement in the reliability of multilayer ceramic capacitors for electronic components and multilayer ceramic capacitors for car-mounted applications is desired.

For example, in the multilayer ceramic capacitor described in Japanese Unexamined Patent Application Publication No. 2022-119088, inner electrode layers are placed inside a multilayer chip that includes dielectric layers including ceramic material that functions as a dielectric. The inner electrode layers are exposed at the surface of the multilayer chip, and outer electrodes are placed so as to be joined to the inner electrode layers. A plating layer including metal, such as copper (Cu), nickel (Ni), and tin (Sn), as a main component is provided on each of the surfaces of the outer electrodes.

Japanese Unexamined Patent Application Publication No. 01-080011 describes that hydrogen generated by a chemical reaction during a plating layer formation process is absorbed into inner electrodes, and the absorbed hydrogen gradually reduces dielectric layers around the inner electrodes to deteriorate insulation resistance.

### SUMMARY OF THE INVENTION

Example embodiments of the present invention reduce or prevent deterioration of insulation resistance in a multilayer ceramic capacitor.

A multilayer ceramic capacitor according to an example embodiment of the present invention includes a multilayer body including a first surface and a second surface opposite each other in a lamination direction, a third surface and a fourth surface opposite each other in a first direction orthogonal to the lamination direction, and a fifth surface and a sixth surface opposite each other in a second direction orthogonal to the lamination direction and the first direction, and an outer electrode on the fifth surface of the multilayer body. The multilayer body includes an inner layer portion including an inner dielectric layer and an inner electrode laminated on the inner dielectric layer in the lamination direction. The inner electrode has an end portion located at the fifth surface. The outer electrode includes an inner base electrode layer on the inner layer portion at the fifth surface and connected to the inner electrode, an inner glass layer on the inner base electrode layer and including a glass component, a plating layer on the inner glass layer, and a connecting portion penetrating through the inner glass layer and electrically connecting the inner base electrode layer to the plating layer.

According to example embodiments of the present invention, it is possible to reduce or prevent deterioration of insulation resistance in a multilayer ceramic capacitor.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of a multilayer ceramic capacitor according to a first example embodiment of the present invention.

FIG. 2 is a cross-sectional view taken along the line II-II in FIG. 1.

FIG. 3 is a cross-sectional view taken along the line III-III in FIG. 1.

FIG. 4 is an exploded perspective view of an inner layer portion according to the first example embodiment of the present invention.

FIG. 5 is an enlarged view of a region R in FIG. 2.

FIG. 6 is a perspective view of a multilayer ceramic capacitor according to a second example embodiment of the present invention.

FIG. 7 is a cross-sectional view taken along the line VII-VII in FIG. 6.

FIG. 8 is a cross-sectional view taken along the line VIII-VIII in FIG. 6.

FIG. 9 is a cross-sectional view taken along the line IX-IX in FIG. 8.

FIG. 10 is a cross-sectional view taken along the line X-X in FIG. 8.

FIG. 11 is a flowchart for illustrating a manufacturing method for a multilayer ceramic capacitor according to the first example embodiment of the present invention.

### DETAILED DESCRIPTION OF THE EXAMPLE EMBODIMENTS

Hereinafter, example embodiments of the present invention will be described with reference to the drawings.

The example embodiments are some example embodiments of the present invention, and the present invention is not limited to the details of those example embodiments. Combinations of the details described in different example embodiments can also be implemented, and the details of those combinations are also included in the scope of the present invention. The drawings are intended to help understand the specification, and can be drawn schematically. The ratios of dimensions of the drawn components or dimensions between the components sometimes do not correspond to the ratios of dimensions of those described in the specification. The components described in the specification can be, for example, not shown in the drawings or drawn in less number.

### 1. Multilayer Ceramic Capacitor

### First Example Embodiment

A multilayer ceramic capacitor according to the first example embodiment of the present invention will be described.

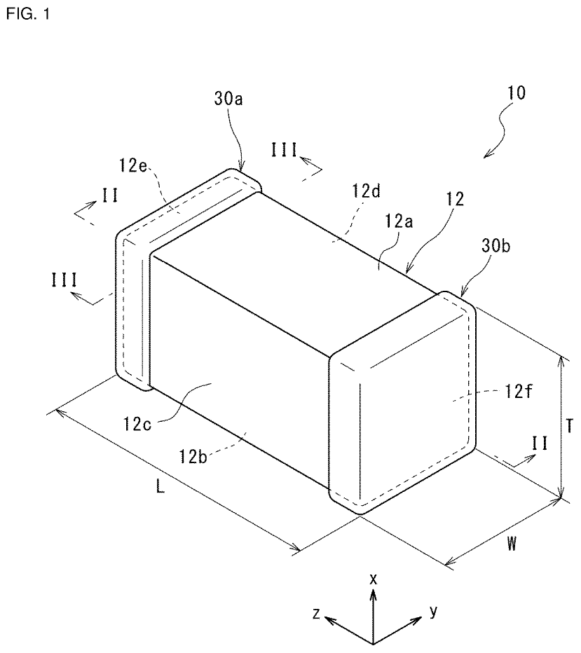

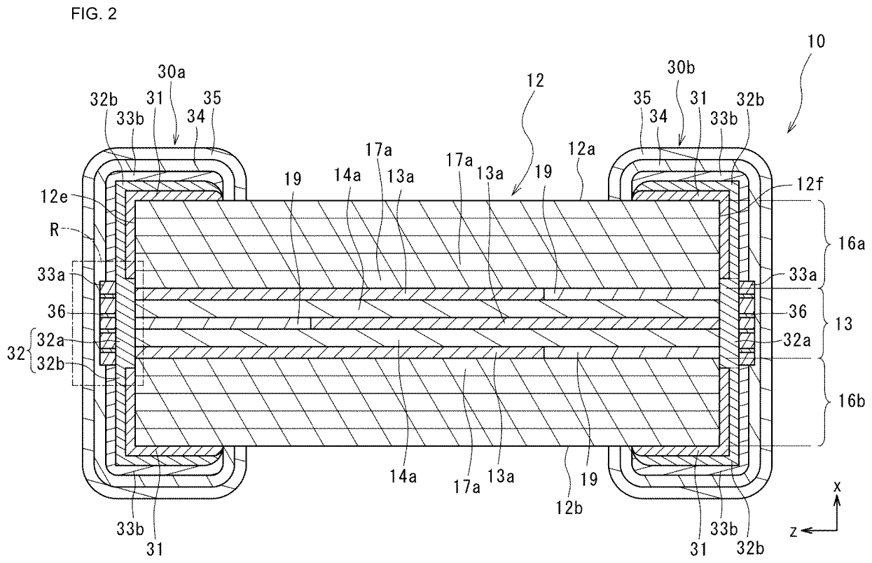

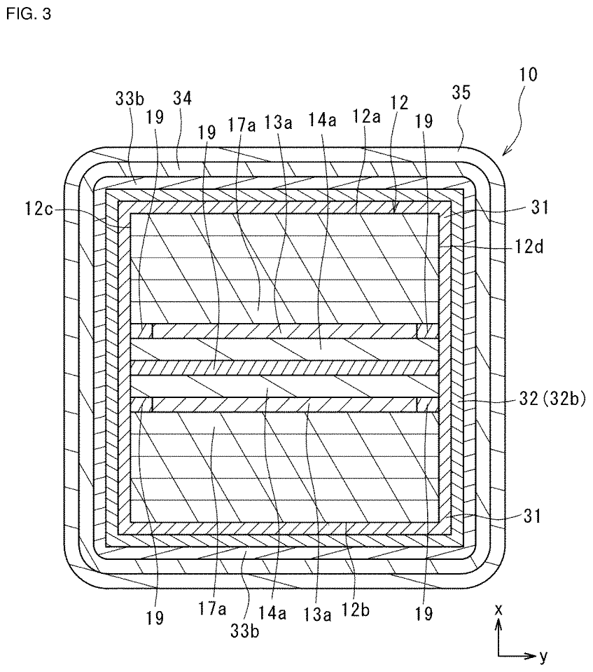

FIG. 1 is a perspective view that shows an example of the multilayer ceramic capacitor according to the first example embodiment of the present invention. FIG. 2 is a cross-sectional view taken along the line II-II in FIG. 1. FIG. 3 is a cross-sectional view taken along the line III-III in FIG. 1.

The drawings may indicate a lamination direction X, a width direction Y, and a length direction Z of the multilayer ceramic capacitor 10, and these directions may be referred to in the following description. The width direction Y of the present example embodiment is an example of a first direction according to the present invention, and the length direction Z is an example of a second direction according to the present invention. The width direction Y of the present example embodiment may also be an example of a second direction according to the present invention, and the length direction Z may also be an example of a first second direction according to the present invention.

Referring to FIG. 1, the multilayer ceramic capacitor 10 includes a multilayer body 12, a first outer electrode 30a, and a second outer electrode 30b. In the following description, if there is no need to specifically distinguish the first outer electrode 30a and the second outer electrode 30b from each other, one of them may simply be referred to as outer electrode 30.

The multilayer body 12 of the present example embodiment has a rectangular parallelepiped shape or a substantially rectangular parallelepiped shape as a whole. The multilayer body 12 includes a first surface 12a and a second surface 12b opposite each other in the lamination direction X, a third surface 12c and a fourth surface 12d opposite each other in the width direction Y, and a fifth surface 12e and a sixth surface 12f opposite each other in the length direction Z. In the present example embodiment, the lamination direction X, the width direction Y, and the length direction Z are orthogonal to one another. In the multilayer body 12, corner portions and ridge portions are desirably rounded. The corner portions refer to the portions where three adjacent sides of the multilayer body 12 intersect. The ridge portions refer to the portions where two adjacent sides of the multilayer body 12 intersect. One or some or all of the pair of first surface 12a and second surface 12b, the pair of third surface 12c and fourth surface 12d, and the pair of fifth surface 12e and sixth surface 12f may include irregularities.

As shown in FIG. 2, the multilayer body 12 includes an inner layer portion 13, a first outer layer portion 16a, and a second outer layer portion 16b. In the following description, if there is no need to specifically distinguish the first outer layer portion 16a and the second outer layer portion 16b from each other, one of them may simply be referred to as outer layer portion 16.

### Inner Layer Portion 13

Referring to FIGS. 2 and 3, the inner layer portion 13 includes a plurality of inner electrodes 13a and a plurality of inner dielectric layers 14a. The inner layer portion 13 is a portion located between the inner electrode 13a closest to the first outer layer portion 16a among the plurality of inner electrodes 13a and the inner electrode 13a closest to the second outer layer portion 16b among the plurality of inner electrodes 13a. In other words, the inner layer portion 13 is a portion located between the inner electrode 13a adjacent to the first outer layer portion 16a and the inner electrode 13a adjacent to the second outer layer portion 16b.

The plurality of inner dielectric layers 14a is laminated in the lamination direction X. In other words, the plurality of inner dielectric layers 14a are arranged in the lamination direction X. The material of each inner dielectric layer 14a is optional. For example, a dielectric ceramic including barium titanate (BaTiO₃) as a main component can be used as the material for the inner dielectric layer 14a. In particular, the material of the inner dielectric layer 14a may have a plurality of crystal grains including a perovskite-type compound with BaTiO₃ as a basic structure. However, instead of BaTiO₃, a dielectric ceramic with a different compound as a main component, such as calcium titanate (CaTiO₃), strontium titanate (SrTiO₃), or calcium zirconate (CaZrO₃), may be used as the material of the inner dielectric layer 14a. A main component, such as BaTiO₃, CaTiO₃, SrTiO₃, or CaZrO₃, added with a compound, such as a manganese (Mn) compound, an iron (Fe) compound, a chromium (Cr) compound, a cobalt (Co) compound, or a nickel (Ni) compound, as a secondary component, in a smaller content range than the main component, may be used as the material of the inner dielectric layer 14a. The thickness, that is, the dimension in the lamination direction X, of the inner dielectric layer 14a is optional and is preferably less than or equal to about 10.0 μm, for example.

Each inner electrode 13a is located between two adjacent dielectric layers in the lamination direction X among the plurality of dielectric layers included in the multilayer body 12. The inner electrode 13a may be located between two adjacent inner dielectric layers 14a in the lamination direction X among the plurality of inner dielectric layers 14a. The inner electrode 13a may be located between the inner dielectric layer 14a and an outer dielectric layer 17a of the outer layer portion 16, which are located adjacent to each other in the lamination direction X. The inner dielectric layer 14a is located between the two adjacent inner electrodes 13a in the lamination direction X. The inner electrode 13a is in contact with the inner dielectric layer 14a.

The inner electrode 13a of the present example embodiment is a plate-shaped electrode. The inner electrode 13a extends in the length direction Z. The inner electrode 13a includes a first end exposed at any one of the fifth surface 12e and the sixth surface 12f, and a second end located inside the multilayer body 12.

Referring to FIG. 2, in the present example embodiment, each inner electrode 13a is exposed at any one of the fifth surface 12e and the sixth surface 12f of the multilayer body 12. The plurality of inner electrodes 13a includes the inner electrodes 13a exposed at the fifth surface 12e and not exposed at the sixth surface 12f, and the inner electrodes 13a exposed at the sixth surface 12f and not exposed at the fifth surface 12e. The inner electrodes 13a exposed at the fifth surface 12e and not exposed at the sixth surface 12f and the inner electrodes 13a exposed at the sixth surface 12f and not exposed at the fifth surface 12e are located alternately in the lamination direction X.

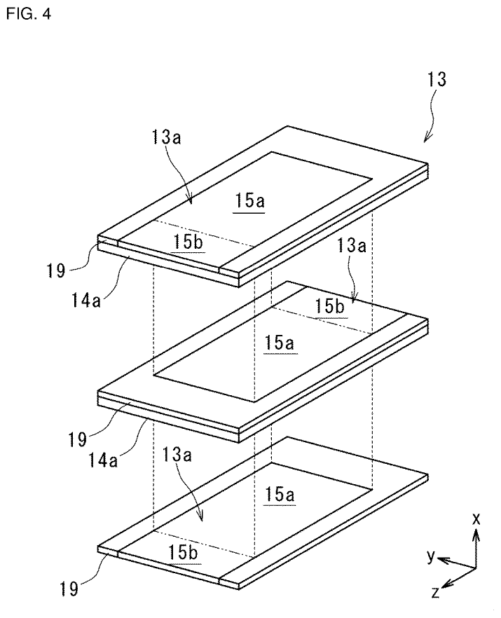

FIG. 4 is an exploded perspective view of the inner layer portion 13. Referring to FIG. 4, each inner electrode 13a includes a counter electrode portion 15a and an extended electrode portion 15b. The counter electrode portion 15a is a portion that faces other adjacent inner electrodes 13a in the lamination direction X among the inner electrodes 13a. The extended electrode portion 15b is a portion of the inner electrode 13a other than the counter electrode portion 15a. A capacitance is generated such that the counter electrode portions 15a of the two adjacent inner electrodes 13a in the lamination direction X face each other with the inner dielectric layer 14a interposed therebetween. Each extended electrode portion 15b is exposed at any one of the fifth surface 12e and the sixth surface 12f.

The shape of the inner electrode 13a is not particularly limited. However, the shape of the inner electrode 13a is preferably rectangular when viewed in the lamination direction X. The corner portions of the counter electrode portions 15a may be chamfered or rounded. The corner portions of the extended electrode portions 15b may be chamfered or rounded.

The inner electrode 13a preferably has a uniform thickness, that is, dimension in the lamination direction X, along the width direction Y. The thickness of the inner electrode 13a at the end portion in the width direction Y may be thicker than the thickness of the inner electrode 13a at a center portion in the width direction Y.

In the present example embodiment, the main component of the inner electrode 13a is copper (Cu). However, the main component of the inner electrode 13a is optional and may be another metal, such as Ni, palladium (Pd), or silver (Ag), instead of Cu. The main component of the inner electrode 13a may be an alloy of Ni, Pd, Ag, Cu, or the like with another metal.

The thickness of the inner electrode 13a is optional. However, the thickness of the inner electrode 13a is preferably, for example, greater than or equal to about 0.2 μm and less than or equal to about 2.0 μm, for example.

### Outer Layer Portion 16

Referring to FIG. 2, the first outer layer portion 16a and the second outer layer portion 16b are respectively on both sides of the inner layer portion 13 in the lamination direction X. The first outer layer portion 16a is on one side (upper side in FIG. 2) of the inner layer portion 13 in the lamination direction X. In other words, the first outer layer portion 16a is on the first surface 12a side of the inner layer portion 13. The second outer layer portion 16b is on the other side (lower side in FIG. 2) of the inner layer portion 13 in the lamination direction X. In other words, the second outer layer portion 16b may be provided on the second surface 12b side of the inner layer portion 13.

The outer layer portion 16 includes a plurality of outer dielectric layers 17a. The plurality of outer dielectric layers 17a is laminated in the lamination direction X. The material of each outer dielectric layer 17a is optional. For example, a dielectric ceramic including BaTiO₃ as a main component can be used as the material of the outer dielectric layer 17a. However, instead of BaTiO₃, a dielectric ceramic including another compound, such as CaTiO₃, SrTiO₃, or CaZrO₃, as a main component may be used as the material of the outer dielectric layer 17a. A main component, such as BaTiO₃, CaTiO₃, SrTiO₃, or CaZrO₃, added with a compound, such as an Mn compound, an Fe compound, a Cr compound, a Co compound, or an Ni compound, as a secondary component, in a smaller content range than the main component may be used. The material of the outer dielectric layer 17a may be made of a main component different from the material of the inner dielectric layer 14a.

Although not shown in the drawings, an electrically insulating layer may be provided on each of the third surface 12c and the fourth surface 12d of the multilayer body 12. When the electrically insulating layers are provided, it is possible to reduce the entry of moisture to the interfaces between the inner electrodes 13a and the inner dielectric layers 14a, the interfaces between the inner electrodes 13a and the outer dielectric layers 17a, and the inside of the multilayer body 12. The electrically insulating layer preferably includes the same or similar components as the inner dielectric layer 14a or the outer dielectric layer 17a. When the electrically insulating layer includes the same or similar components as the inner dielectric layer 14a, the adhesion between the electrically insulating layers and the inner dielectric layers 14a is improved. When the electrically insulating layer has the same or similar components as the outer dielectric layer 17a, the adhesion between the electrically insulating layers and the outer dielectric layers 17a is improved.

The electrically insulating layers may also be located to be joined to the inner electrodes 13a. In this case, the surfaces of the electrically insulating layers on the sides not joined to the inner electrodes 13a become the third surface 12c and the fourth surface 12d. In other words, when the electrically insulating layers are joined to the inner electrodes 13a, the surfaces of the electrically insulating layers, on the opposite sides from the inner electrodes 13a define the third surface 12c and the fourth surface 12d of the multilayer body 12.

Each of the electrically insulating layers preferably includes an innermost inner layer in the width direction Y and an outermost outer layer in the first direction. Providing the inner layer and the outer layer makes it possible to easily find a boundary through observation with an optical microscope based on the difference in degree of sintering between the inner layer and the outer layer. In other words, there is a boundary between the inner layer and the outer layer. A plurality of boundaries may be provided.

The electrically insulating layer is not limited to a two-layer structure and may also have a structure with three or more layers. When the electrically insulating layer includes three or more layers, the layer on the innermost side in the width direction Y is defined as the inner layer, and the layer on the outermost side in the width direction Y is defined as the outer layer.

A step layer 19 is located in the same plane as a corresponding one of the inner electrodes 13a. When the step layer 19 is not provided, there is a difference in the thickness of the inner layer portion 13 between a portion where the inner electrode 13a is located and a portion where the inner electrode 13a is not provided, with the result that distortion occurs during pressing or the like in a manufacturing process for the multilayer ceramic capacitor 10 (described later), which may lead to structural defects. In contrast, in the present example embodiment, the step layer 19 can fill a step corresponding to the thickness of the inner electrode 13a in the lamination direction X, so it is possible to reduce distortion during pressing or the like in the manufacturing process for the multilayer ceramic capacitor 10 to reduce or prevent structural defects. The step layer 19 preferably has the same or substantially the same thickness as the inner electrode 13a provided in the same plane. The step layer 19 preferably contains the same or substantially the same components as the inner dielectric layer 14a.

### Outer Electrode 30

The first outer electrode 30a is on the fifth surface 12e side of the multilayer body 12. In the present example embodiment, the first outer electrode 30a is on the first surface 12a, the second surface 12b, the third surface 12c, the fourth surface 12d, and the fifth surface 12e. The first outer electrode 30a may be provided only provided on the fifth surface 12e of the multilayer body 12. However, the first outer electrode 30a is preferably continuously provided on the fifth surface 12e, the first surface 12a, and the second surface 12b. The first outer electrode 30a is more preferably additionally provided on the third surface 12c and the fourth surface 12d. The first outer electrode 30a is joined to the inner electrodes 13a exposed at the fifth surface 12e of the multilayer body 12. In this way, the first outer electrode 30a is electrically connected to the inner electrodes 13a located at the fifth surface 12e of the multilayer body 12.

The second outer electrode 30b is on the sixth surface 12f side of the multilayer body 12. In the present example embodiment, the second outer electrode 30b is on the first surface 12a, the second surface 12b, the third surface 12c, the fourth surface 12d, and the sixth surface 12f. The second outer electrode 30b may be provided only on the sixth surface 12f of the multilayer body 12. However, the second outer electrode 30b is preferably continuously on the sixth surface 12f, the first surface 12a, and the second surface 12b. The second outer electrode 30b is preferably provided additionally on the third surface 12c and the fourth surface 12d. The second outer electrode 30b is joined to the inner electrodes 13a exposed at the sixth surface 12f of the multilayer body 12. In this way, the second outer electrode 30b is electrically connected to the inner electrodes 13a located at the sixth surface 12f of the multilayer body 12.

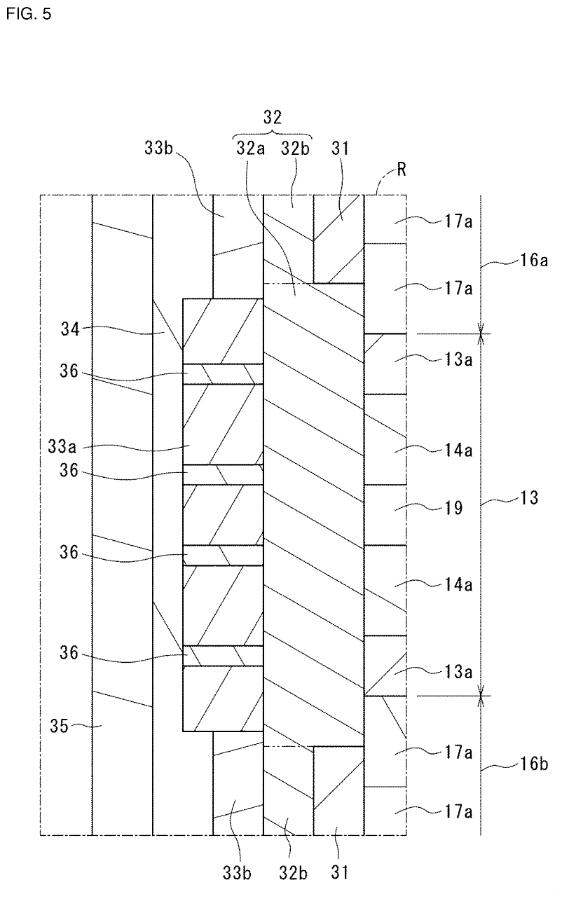

FIG. 5 is an enlarged view of a region R in FIG. 2. FIG. 5 shows a partially enlarged view of the first outer electrode 30a. The second outer electrode 30b also has a similar configuration to that of the first outer electrode 30a.

The outer electrode 30 includes a glass layer 31 and a base electrode layer 32 located so as to cover the glass layer 31, as shown in FIGS. 2, 3, and 5. The outer electrode 30 includes an inner glass layer 33a and an outer glass layer 33b on the base electrode layer 32, a plating layer 34 on the inner glass layer 33a and the outer glass layer 33b, and a surface plating layer 35 on the plating layer 34.

The glass layer 31 includes glass components. The glass components include at least one of boron (B), silicon (Si), barium (Ba), magnesium (Mg), aluminum (Al), and lithium (Li). In the present example embodiment, at least one selected from among B, Ba, Mg, Al, or Li is added to silicon dioxide (SiO₂) as the glass components of the glass layer 31. The glass layer 31 is located at a position that overlaps the outer layer portion 16 when the multilayer body 12 is viewed in the length direction Z. The glass layer 31 is on both sides (upper and lower sides in FIG. 2) of the inner base electrode layer 32a (described later) in the lamination direction X.

The glass layer 31 of the first outer electrode 30a is provided on the fifth surface 12e side of the multilayer body 12. The glass layer 31 of the first outer electrode 30a of the present example embodiment is continuously provided on the first surface 12a, the second surface 12b, the third surface 12c, the fourth surface 12d, and the fifth surface 12e of the multilayer body 12. The glass layer 31 of the first outer electrode 30a may be provided only on the fifth surface 12e of the multilayer body 12. However, the glass layer 31 is preferably continuously on the fifth surface 12e, the first surface 12a, and the second surface 12b. The glass layer 31 of the first outer electrode 30a is preferably provided additionally on the third surface 12c and the fourth surface 12d.

The glass layer 31 of the first outer electrode 30a is on the outer layer portion 16 at the fifth surface 12e of the multilayer body 12. The glass layer 31 of the first outer electrode 30a is on the outer dielectric layer 17a. The glass layer 31 of the first outer electrode 30a of the present example embodiment is not connected to the inner electrodes 13a exposed at the fifth surface 12e of the multilayer body 12. However, the glass layer 31 may be connected to the inner electrodes 13a. The glass layer 31 of the first outer electrode 30a has a thinner thickness at the end portion on the central side of the multilayer body 12 in the length direction Z than the other portions on each of the first surface 12a and the second surface 12b. Although not shown in the drawings, the glass layer 31 of the first outer electrode 30a preferably has a thinner thickness at the end portion on the central side in the length direction Z than the other portions on each of the third surface 12c and the fourth surface 12d.

The glass layer 31 of the second outer electrode 30b is on the sixth surface 12f side of the multilayer body 12. The glass layer 31 of the second outer electrode 30b of the present example embodiment is continuously provided on the first surface 12a, the second surface 12b, the third surface 12c, the fourth surface 12d, and the sixth surface 12f of the multilayer body 12. The glass layer 31 of the second outer electrode 30b may be provided only on the sixth surface 12f of the multilayer body 12. However, the glass layer 31 is preferably continuously provided on the sixth surface 12f, the first surface 12a, and the second surface 12b. The glass layer 31 of the second outer electrode 30b is preferably additionally provided on the third surface 12c and the fourth surface 12d.

The glass layer 31 of the second outer electrode 30b is on the outer layer portion 16 at the sixth surface 12f of the multilayer body 12. The glass layer 31 of the second outer electrode 30b is on the outer dielectric layer 17a. The glass layer 31 of the second outer electrode 30b of the present example embodiment is not connected to the inner electrodes 13a exposed at the sixth surface 12f of the multilayer body 12. However, the glass layer 31 may be connected to the inner electrodes 13a. The glass layer 31 of the second outer electrode 30b has a thinner thickness at the end portion on the central side of the multilayer body 12 in the length direction Z than the other portions on each of the first surface 12a and the second surface 12b. Although not shown in the drawings, the glass layer 31 of the second outer electrode 30b preferably has a thinner thickness at the end portion on the central side in the length direction Z than the other portions on each of the third surface 12c and the fourth surface 12d.

The base electrode layer 32 includes a sintered layer. The sintered layer includes glass components and metal. The glass components included in the sintered layer include at least one selected from among B, Si, Ba, Mg, Al, or Li. In the present example embodiment, at least one selected from among B, Ba, Mg, Al, or Li is added to silicon dioxide (SiO₂) as the glass components included in the sintered layer. In the present example embodiment, in addition to Si, the glass components include Al, Ba, or O. The metal included in the sintered layer includes, for example, at least one selected from among Cu, Ni, Ag, Pd, Ag—Ni alloy, or gold (Au).

The base electrode layer 32 includes an inner base electrode layer 32a and an outer base electrode layer 32b. The inner base electrode layer 32a overlaps the inner layer portion 13 when the base electrode layer 32 is viewed in the length direction Z. The outer base electrode layer 32b overlaps the outer layer portion 16 when the base electrode layer 32 is viewed in the length direction Z. The outer base electrode layer 32b is provided on the glass layer 31. The outer base electrode layer 32b covers the glass layer 31 from outside in the length direction Z.

The inner base electrode layer 32a of the first outer electrode 30a is located on the inner layer portion 13 at the fifth surface 12e of the multilayer body 12. The inner base electrode layer 32a of the first outer electrode 30a is connected to the inner electrodes 13a exposed at the fifth surface 12e of the multilayer body 12. In this way, the inner base electrode layer 32a of the first outer electrode 30a is electrically connected to the inner electrodes 13a located at the fifth surface 12e of the multilayer body 12.

The inner base electrode layer 32a of the second outer electrode 30b is located on the inner layer portion 13 at the sixth surface 12f of the multilayer body 12. The inner base electrode layer 32a of the second outer electrode 30b is connected to the inner electrodes 13a exposed at the sixth surface 12f of the multilayer body 12. In this way, the inner base electrode layer 32a of the second outer electrode 30b is electrically connected to the inner electrodes 13a located at the sixth surface 12f of the multilayer body 12.

The outer base electrode layer 32b of the first outer electrode 30a of the present example embodiment is continuously located at positions facing the fifth surface 12e, the first surface 12a, the second surface 12b, the third surface 12c, and the fourth surface 12d of the multilayer body 12. The outer base electrode layer 32b of the first outer electrode 30a may be located at a position facing only the fifth surface 12e of the multilayer body 12. However, the outer base electrode layer 32b is preferably continuously provided additionally at positions facing the first surface 12a and the second surface 12b. The outer base electrode layer 32b of the first outer electrode 30a is preferably provided additionally at positions facing the third surface 12c and the fourth surface 12d. The outer base electrode layer 32b of the first outer electrode 30a is connected to the inner base electrode layer 32a of the first outer electrode 30a. In this way, the outer base electrode layer 32b of the first outer electrode 30a is electrically connected to the inner electrodes 13a exposed at the fifth surface 12e of the multilayer body 12. The outer base electrode layer 32b of the first outer electrode 30a may be provided between the third surface 12c or the fourth surface 12d and the inner electrodes 13a.

The outer base electrode layer 32b of the second outer electrode 30b of the present example embodiment is continuously located at positions facing the sixth surface 12f, the first surface 12a, the second surface 12b, the third surface 12c, and the fourth surface 12d of the multilayer body 12. The outer base electrode layer 32b of the second outer electrode 30b may be provided only at a position facing only the sixth surface 12f of the multilayer body 12. However, the outer base electrode layer 32b is preferably continuously provided additionally at positions facing the first surface 12a and the second surface 12b. The outer base electrode layer 32b of the second outer electrode 30b is preferably provided additionally at positions facing the third surface 12c and the fourth surface 12d. The outer base electrode layer 32b of the second outer electrode 30b is connected to the inner base electrode layer 32a of the second outer electrode 30b. In this way, the outer base electrode layer 32b of the second outer electrode 30b is electrically connected to the inner electrodes 13a exposed at the sixth surface 12f of the multilayer body 12. The outer base electrode layer 32b of the second outer electrode 30b may be provided between the third surface 12c or the fourth surface 12d and the inner electrodes 13a.

The inner glass layer 33a includes glass components. The glass components include at least one selected from among B, Si, Ba, Mg, Al, and Li. In the present example embodiment, at least one selected from among B, Ba, Mg, Al, or Li is added to silicon dioxide (SiO₂) as the glass components of the inner glass layer 33a. The inner glass layer 33a is on the inner base electrode layer 32a. In other words, the inner glass layer 33a is located at a position that overlaps the inner base electrode layer 32a when viewed in the length direction Z. In other words, the inner glass layer 33a covers the inner base electrode layer 32a. Coating the inner base electrode layer 32a with the inner glass layer 33a reduces the area of an alloy of the inner base electrode layer 32a and the plating layer 34, which occurs when the plating layer 34 is formed. Thus, it is possible to reduce or prevent the degradation of insulation resistance by reducing the amount of hydrogen absorbed in the inner electrodes 13a.

The thickness, that is, the dimension in the length direction Z of the multilayer body 12, of the inner glass layer 33a is preferably greater than or equal to about 0.2 μm and less than or equal to about 3.5 μm, for example. By increasing the thickness to greater than about 0.2 μm, for example, it is possible to further reduce or prevent the absorption of hydrogen that is produced when the plating layer 34 is formed. When the thickness is less than about 3.5 μm, for example, it is possible to reduce or prevent the extension of time taken to form connecting portions 36 (described later).

The outer glass layer 33b includes glass components. The glass components include at least one selected from among B, Si, Ba, Mg, Al, or Li. In the present example embodiment, at least one selected from among B, Ba, Mg, Al, or Li is added to silicon dioxide (SiO₂) as the glass components of the outer glass layer 33b. The outer glass layer 33b is on the outer base electrode layer 32b. In other words, the outer glass layer 33b is located at a position that overlaps the outer base electrode layer 32b when viewed in the length direction Z. In other words, the outer glass layer 33b covers the outer base electrode layer 32b.

When the inner glass layer 33a and the outer glass layer 33b are continuously provided, the region located on the outer base electrode layer 32b side from a position, for example, about 5 μm from the boundary between the inner base electrode layer 32a and the outer base electrode layer 32b toward the inner base electrode layer 32a in the lamination direction X is defined as the outer glass layer 33b.

The outer glass layer 33b extends along the shape of the outer electrode 30 toward the distal end of the outer electrode 30. At this time, the distal end of the outer glass layer 33b may have a tapered shape and does not need to reach the distal end of the outer electrode 30.

The outer glass layer 33b of the first outer electrode 30a of the present example embodiment is continuously provided at positions facing the fifth surface 12e, the first surface 12a, the second surface 12b, the third surface 12c, and the fourth surface 12d of the multilayer body 12. The outer glass layer 33b of the first outer electrode 30a may be provided only on the fifth surface 12e of the multilayer body 12. However, the outer glass layer 33b is preferably continuously provided additionally on the first surface 12a and the second surface 12b. The outer glass layer 33b of the first outer electrode 30a is preferably provided additionally on the third surface 12c and the fourth surface 12d.

The outer glass layer 33b of the second outer electrode 30b of the present example embodiment is continuously located at positions facing the sixth surface 12f, the first surface 12a, the second surface 12b, the third surface 12c, and the fourth surface 12d of the multilayer body 12. The outer glass layer 33b of the second outer electrode 30b may be provided only on the sixth surface 12f of the multilayer body 12. However, the outer glass layer 33b is preferably continuously provided additionally on the first surface 12a and the second surface 12b. The outer glass layer 33b of the second outer electrode 30b is preferably provided additionally on the third surface 12c and the fourth surface 12d.

The thickness of the outer glass layer 33b in a direction perpendicular to the multilayer body 12 is thinner than the thickness of the inner glass layer 33a in a direction perpendicular to the multilayer body 12. For example, the thickness of a portion of the outer glass layer 33b, facing the first surface 12a, is the thickness in a direction perpendicular to the first surface 12a, that is, the lamination direction X. Similarly, the thickness of a portion of the inner glass layer 33a, facing the first surface 12a, is the thickness in a direction perpendicular to the first surface 12a, that is, the lamination direction X. The thickness of a portion of the outer glass layer 33b, facing the fifth surface 12e or the sixth surface 12f, is the thickness in a direction perpendicular to the fifth surface 12e or the sixth surface 12f, that is, the length direction Z. Similarly, the thickness of a portion of the inner glass layer 33a, facing the fifth surface 12e or the sixth surface 12f of the multilayer body 12, is the thickness in a direction perpendicular to the fifth surface 12e or the sixth surface 12f, that is, the length direction Z.

The plating layer 34 covers the inner glass layer 33a and the outer glass layer 33b. The plating layer 34 is on the inner glass layer 33a and the outer glass layer 33b. The plating layer 34 of the present example embodiment is an Ni plating layer. In other words, the main component of the plating layer 34 is Ni. When the plating layer 34 is an Ni plating layer, it is possible to reduce or prevent the erosion of the inner base electrode layer 32a by solder used at the time of mounting the multilayer ceramic capacitor 10, that is, so-called copper dissolution.

The surface plating layer 35 covers the plating layer 34. The surface plating layer 35 is provided on the plating layer 34. The surface plating layer 35 of the present example embodiment is an Sn plating layer. In other words, the main component of the surface plating layer 35 is Sn.

As shown in FIG. 5, the outer electrode 30 includes connecting portions 36 that extend through the inner glass layer 33a and that electrically connect the inner base electrode layer 32a to the plating layer 34.

The connecting portions 36 include components similar to those of the plating layer 34. In other words, when the plating layer 34 is an Ni plating layer, the connecting portions 36 are made of Ni. When the plating layer 34 is an Sn plating layer, the connecting portions 36 are made of Sn. With the presence of the connecting portions 36, it is possible to form the uniform plating layer 34 on the inner glass layer 33a and to shorten a current path, so this also leads to a decrease in the electrical resistance of the multilayer ceramic capacitor 10.

The connecting portions 36 can be checked by observing the cross section obtained by grinding the multilayer body 12 in the width direction Y, that is, the cross section including the lamination direction X and the length direction Z. The connecting portions 36 in the cross section shown in FIG. 5 each have a columnar shape. However, the connecting portions 36 are not limited thereto and may have a shape that extends in the width direction Y. In that case, the connecting portions 36 can be checked by observing the cross section obtained by grinding the cross section in the lamination direction X, that is, the cross section including the width direction Y and the length direction Z.

The inner base electrode layer 32a preferably satisfies the relationship (Area of the glass components)/((Area of the glass components)+(Area of the metal components))≤about 0.2 in the cross section including the lamination direction X and the length direction Z (for example, the cross section when the multilayer ceramic capacitor 10 is ground in the width direction Y up to half the dimension in the width direction Y). In other words, in the cross section including the lamination direction X and the length direction Z, the area of the glass components included in the inner base electrode layer 32a is smaller than or equal to about 20% of the sum of the areas of the glass components and metal components included in the inner base electrode layer 32a, for example. When the areas of the glass components and metal components included in the inner base electrode layer 32a satisfy the above-described relationship, the inner base electrode layer 32a has high-density metal components, so it is possible to reduce or prevent the entry of moisture to the inner electrodes 13a.

(Area of the glass components)/((Area of the glass components)+ (Area of the metal components)) is, for example, measured as follows. The multilayer ceramic capacitor 10 is ground in the width direction Y up to half the dimension in the width direction Y. When there are inner electrodes 13a, grinding may extend up to about ⅓ instead of about ½, for example. On the surface exposed by grinding, a position about 1.5 μm away from the multilayer body 12 in the length direction Z from the inner electrode 13a closest to the outer layer portion 16 is defined as a reference position. An area ratio of glass is acquired in a range about 20 μm away from the reference position toward the central side of the multilayer body 12 in the lamination direction X and about 2.0 μm away from the multilayer body 12 from the reference position in the length direction Z, for example. The area ratio of glass is, for example, calculated by binarizing an image into glass components and metal components with image processing software (for example, of the US National Institutes of Health). The image is measured under the conditions that the magnification of a field emission scanning electron microscope (FE-SEM) is 2000 times, the acceleration voltage is 15.0 kV, and WD is 7.5 mm, for example.

### Advantageous Effects

With the multilayer ceramic capacitor 10 according to the present example embodiment, the following advantageous effects are obtained.

Since the inner glass layer 33a including glass components is on the inner base electrode layer 32a, the area of an alloy of the inner base electrode layer 32a and the plating layer 34, which occurs when the plating layer 34 is formed, reduces. Thus, it is possible to reduce the amount of hydrogen absorbed in the inner electrodes 13a and to reduce or prevent the degradation of insulation resistance.

The thickness of the inner glass layer 33a in the length direction of the multilayer body 12, the inner glass layer 33a including glass components of the outer electrode, is preferably greater than or equal to about 0.2 μm and less than or equal to about 3.5 μm, for example. By increasing the thickness to greater than about 0.2 μm, it is possible to further reduce or prevent the absorption of hydrogen that is produced when the plating layer 34 is formed. When the thickness is less than about 3.5 μm, it is possible to reduce or prevent the extension of time taken to form the connecting portions 36.

The outer electrode 30 includes the connecting portions 36 that extend through the inner glass layer 33a and that electrically connect the inner base electrode layer 32a to the plating layer 34. With the presence of the connecting portions 36, it is possible to form the uniform plating layer 34 on the inner glass layer 33a and to shorten a current path, so this also leads to a decrease in the electrical resistance of the multilayer ceramic capacitor 10.

The thickness of the inner glass layer 33a in the length direction Z of the multilayer body 12, the inner glass layer 33a including glass components of the outer electrode 30, is greater than or equal to about 0.2 μm and less than or equal to about 3.5 μm, for example. With this configuration, it is possible to efficiently form the plating layer 34 while further reducing or preventing the absorption of hydrogen.

The inner base electrode layer 32a satisfies the relationship (Area of glass)/((Area of glass)+ (Area of metal components))≤about 0.2. With this configuration, since the inner base electrode layer 32a has high-density metal components, so it is possible to reduce or prevent the entry of moisture to the inner electrodes 13a.

### Second Example Embodiment

Hereinafter, a multilayer ceramic capacitor according to the second example embodiment of the present invention will be described. The multilayer ceramic capacitor according to the second example embodiment has a similar configuration to the multilayer ceramic capacitor according to the first example embodiment except the shape and placement of the first inner electrodes, the shape and placement of the second inner electrodes, and the number and configuration of the outer electrodes. Like reference signs denote the same or similar components to those of the first example embodiment in the second example embodiment, and the detailed description thereof is omitted.

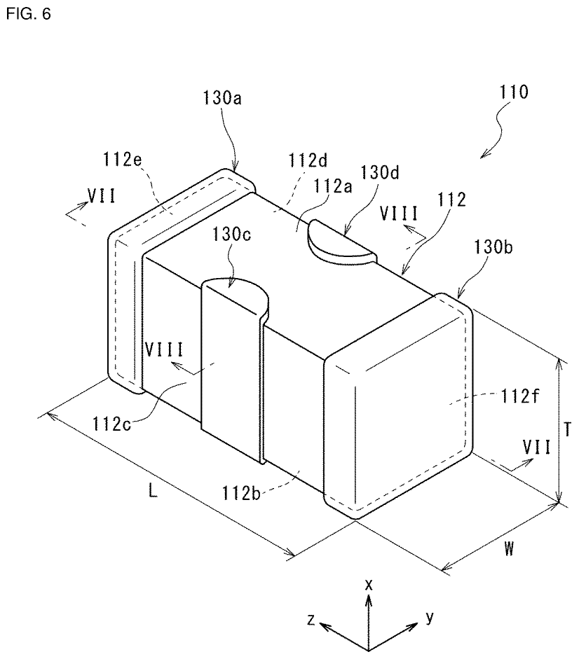

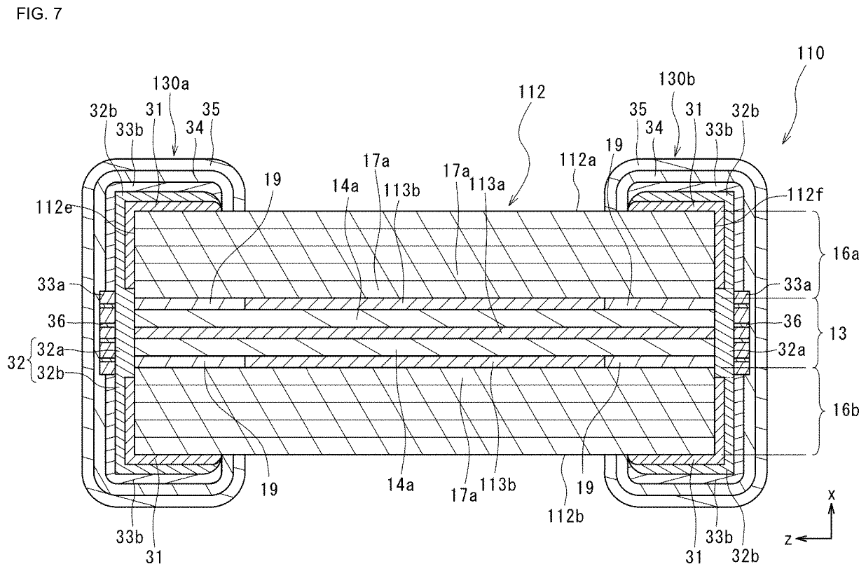

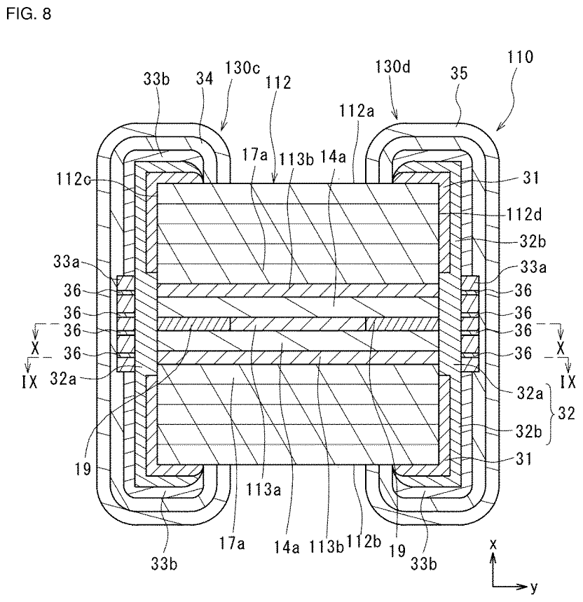

FIG. 6 is a perspective view of a multilayer ceramic capacitor 110 according to the present example embodiment. FIG. 7 is a cross-sectional view taken along the line VII-VII in FIG. 6. FIG. 8 is a cross-sectional view taken along the line VIII-VIII in FIG. 6.

Referring to FIG. 6, the multilayer ceramic capacitor 110 of the present example embodiment includes a multilayer body 112, and four outer electrodes 130a, 130b, 130c, 130d. In the following description, if there is no need to specifically distinguish the four outer electrodes 130a, 130b, 130c, 130d from one another, one of the four outer electrodes 130a, 130b, 130c, 130d may simply be referred to as outer electrode 130.

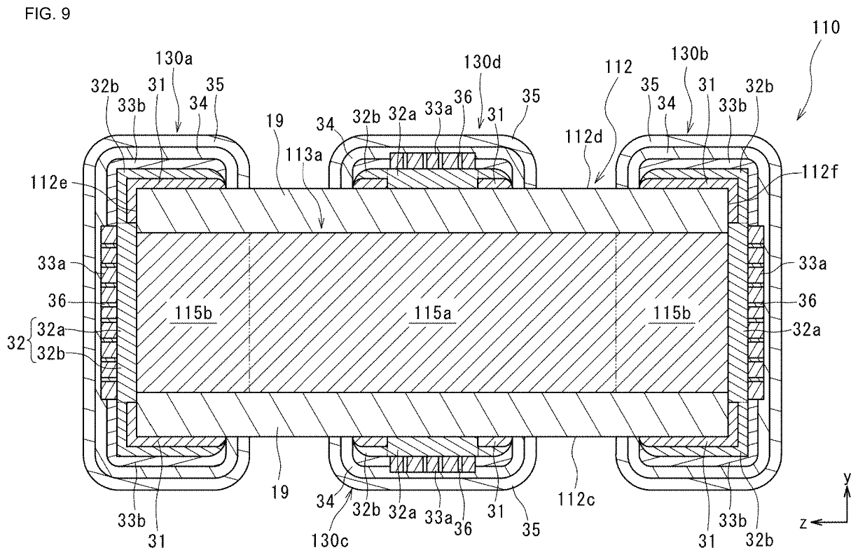

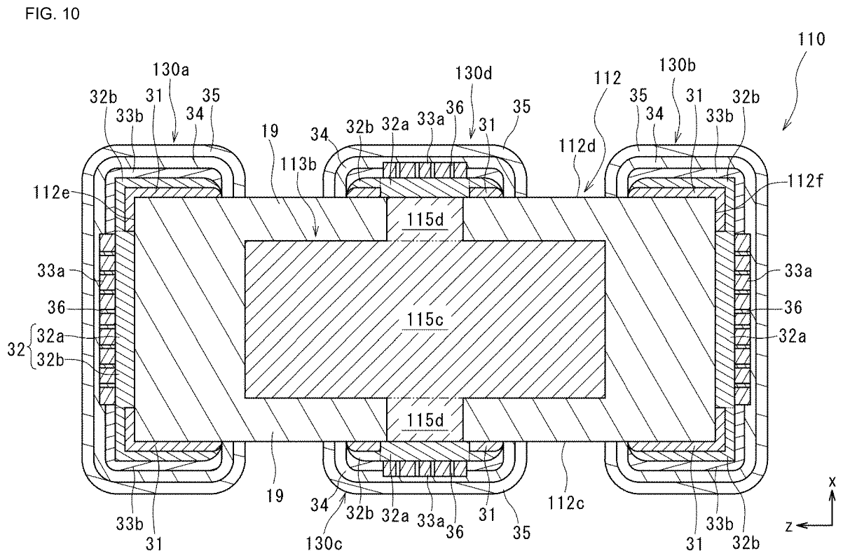

Referring to FIGS. 7 and 8, inner electrodes of the present example embodiment include a first inner electrode 113a and second inner electrodes 113b. As shown in FIG. 9, the first inner electrode 113a includes a counter electrode portion 115a and two extended electrode portions 115b. Each of the extended electrode portions 115b is exposed at any one of a fifth surface 112e and a sixth surface 112f. As shown in FIG. 10, the second inner electrode 113b includes a counter electrode portion 115c and two extended electrode portions 115d. Each of the extended electrode portions 115d is exposed at any one of a third surface 112c and a fourth surface 112d. The extended electrode portion 115b and the counter electrode portion 115a shown in FIG. 9 are equal or substantially equal in the dimension in the width direction Y to each other. However, the dimension in the width direction Y of the extended electrode portion 115b may narrow as it approaches the closest one of the fifth surface 112e and the sixth surface 112f. The first inner electrode 113a and the second inner electrode 113b are extending across the inner dielectric layer 14a in the lamination direction X.

The outer electrodes 130 are respectively located at four sides of the multilayer body 112 when the multilayer body 112 is viewed in the lamination direction X. Each of the first outer electrode 130a and the second outer electrode 130b covers a portion of a first surface 112a, a portion of a second surface 112b, a portion of the third surface 112c, a portion of the fourth surface 112d, and the fifth surface 112e or the sixth surface 112f, of the multilayer body 112. The first outer electrode 130a and the second outer electrode 130b are electrically connected to the first inner electrode 113a. Each of the third outer electrode 130c and the fourth outer electrode 130d covers part of the first surface 112a, a portion of the second surface 112b, and the third surface 112c or the fourth surface 112d, of the multilayer body 112. The third outer electrode 130c and the fourth outer electrode 130d are electrically connected to the second inner electrodes 113b.

The outer electrode 130 has a similar configuration to the outer electrode 30 according to the first example embodiment. The outer electrode 130 includes a glass layer 31 and a base electrode layer 32 covering the glass layer 31, as shown in FIGS. 7, 8, 9, and 10. The outer electrode 130 includes an inner glass layer 33a and an outer glass layer 33b on the base electrode layer 32, a plating layer 34 on the inner glass layer 33a and the outer glass layer 33b, and a surface plating layer 35 on the plating layer 34. The base electrode layers 32 of the outer electrodes 130a, 130b are examples of the first base electrode layer, and the base electrode layers 32 of the outer electrodes 130c, 130d are examples of the second base electrode layer. The inner glass layers 33a of the outer electrodes 130a, 130b are examples of the first inner glass layer, and the inner glass layers 33a of the outer electrodes 130c, 130d are examples of the second inner glass layer. The plating layers 34 of the outer electrodes 130a, 130b are examples of the first plating layer, and the plating layers 34 of the outer electrodes 130c, 130d are examples of the second plating layer.

In the present example embodiment, each of the four outer electrodes 130a, 130b, 130c, 130d has the above-described configuration, that is, a similar configuration to the outer electrode 30 according to the first example embodiment. However, the configuration is not limited thereto. Two outer electrodes 130 located at facing positions of the four outer electrodes 130a, 130b, 130c, 130d may have the above-described configuration. Only the outer electrode 130a and the outer electrode 130b may have the above-described configuration or only the outer electrode 130c and the outer electrode 130d may have the above-described configuration.

The base electrode layer 32 includes an inner base electrode layer 32a and an outer base electrode layer 32b. The inner base electrode layer 32a overlaps the inner layer portion 13 when the base electrode layer 32 is viewed in the length direction Z or the width direction Y. The outer base electrode layer 32b overlaps the outer layer portion 16 when the base electrode layer 32 is viewed in the length direction Z or the width direction Y. The outer base electrode layer 32b is on the glass layer 31. The outer base electrode layer 32b covers the glass layer 31 from outside in the length direction Z.

As shown in FIGS. 7, 8, 9, and 10, the outer electrode 130 includes connecting portions 36 that extend so as to penetrate through the inner glass layer 33a and that electrically connect the inner base electrode layer 32a to the plating layer 34. The connecting portions 36 of the outer electrodes 130a, 130b are examples of the first connecting portion, and the connecting portions 36 of the outer electrodes 130c, 130d are examples of the second connecting portion.

In the multilayer ceramic capacitor 110 of the second example embodiment, when the configuration of the outer electrode 30 of the multilayer ceramic capacitor 10 according to the first example embodiment is applied to the outer electrodes 130 to which a positive potential is applied, among the four outer electrodes 130a, 130b, 130c, 130d, similar operation and advantageous effects to those of the multilayer ceramic capacitor 10 according to the first example embodiment are obtained. When the configuration of the outer electrode 30 of the multilayer ceramic capacitor 10 according to the first example embodiment is applied to all the four outer electrodes 130a, 130b, 130c, 130d, similar operation and advantageous effects to those of the multilayer ceramic capacitor 10 according to the first example embodiment are obtained.

### 2. Manufacturing Method for Multilayer Ceramic Capacitor

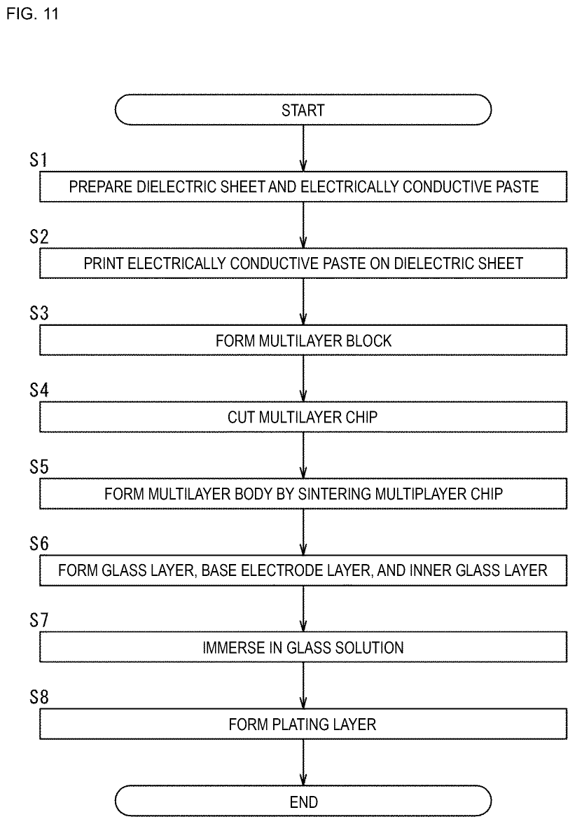

Hereinafter, a non-limiting example of a manufacturing method for a multilayer ceramic capacitor will be described with reference to FIG. 11. FIG. 11 is a flowchart for illustrating a manufacturing method for a multilayer ceramic capacitor. In the following description, a manufacturing method for the multilayer ceramic capacitor 10 according to the first example embodiment will be, for example, described. The multilayer ceramic capacitor 110 according to the second example embodiment can be manufactured with a similar manufacturing method to the manufacturing method for the multilayer ceramic capacitor 10 according to the first example embodiment.

In step S1, dielectric sheets, an electrically conductive paste for inner electrodes, and an electrically conductive paste for outer electrodes are prepared. The dielectric sheet, the electrically conductive paste for inner electrodes, and the electrically conductive paste for outer electrodes include binders and solvents.

In step S2, by printing with the electrically conductive paste for inner electrodes onto the dielectric sheet in a predetermined pattern, a dielectric sheet for an inner layer portion, in which an inner electrode pattern of the inner layer portion 13 is printed on the dielectric sheet, is formed. Printing with the electrically conductive paste for inner electrodes onto the dielectric sheet may be performed by, for example, screen printing or gravure printing.

In step S3, the dielectric sheet and the dielectric sheet for inner electrodes are laminated and pressed in a lamination direction by, for example, isostatic press to form a multilayer block.

In step S4, a multilayer chip is cut by cutting the multilayer block to a predetermined size. After that, corner portions and ridge portions of the multilayer chip may be rounded by barrel polishing or the like.

In step S5, the multilayer body 12 according to the present example embodiment is formed by firing the multilayer chip in an air atmosphere.

In step S6, an electrically conductive paste including glass components and metal is applied to the third surface 12c to the sixth surface 12f by, for example, dipping or a method of applying an electrically conductive paste by extruding the electrically conductive paste through a slit plate. After that, the glass layers 31, the inner base electrode layers 32a, the outer base electrode layers 32b, the inner glass layers 33a, and the outer glass layers 33b are formed through sintering process.

In step S6, when the content of glass components in the electrically conductive paste including the glass components is increased, the thickness of the inner glass layer 33a can be increased. When the temperature for sintering process is increased, the thickness of the inner glass layer 33a increases.

In step S7, the glass layers 31, the inner base electrode layers 32a, the outer base electrode layers 32b, the inner glass layers 33a, and the outer glass layers 33b formed in step S6 are immersed in a glass solution to form cracks in the inner glass layers 33a. The cracks are formed so as to extend through each inner glass layer 33a in the thickness direction.

In step S8, the plating layer 34 is formed so as to be connected to the inner base electrode layer 32a and the outer base electrode layer 32b. Electrolytic plating is preferably used as a plating process. Barrel plating is preferably used as a plating method. At this time, nickel for forming the plating layer 34 moves along the cracks formed in step S7 to form the connecting portions 36.

When four outer electrodes are on the multilayer body 112 as in the case of the second example embodiment, the glass layers 31, the inner base electrode layers 32a, the outer base electrode layers 32b, the inner glass layers 33a, and the outer glass layers 33b are on the third surface to the sixth surface in step S6. In step S7, when the glass layers 31, the base electrode layers 32, the inner glass layers 33a, and the outer glass layers 33b on desired surfaces of the third surface to the sixth surface are selectively immersed in a glass solution, the outer electrodes according to example embodiments of the present invention can be formed on the desired surfaces.

As described above, the example embodiments of the present invention have been described in the specification. However, the present invention is not limited thereto. Various modifications may be added to the example embodiments described above in terms of mechanism, shape, material, number, position, arrangement, or the like without departing from the scope of the present invention, and the present invention encompasses those modifications.

In an example, the step layers 19 are provided in the same planes as the inner electrodes 13a in FIGS. 2, 3, and 4. However, the step layers 19 do not need to be provided in the same planes as the inner electrodes 13a. The step layers 19 are provided in the same planes as the first inner electrode 113a and the second inner electrodes 113b in FIGS. 7 to 10. However, the step layers 19 do not need to be provided in the same planes as the first inner electrode 113a and the second inner electrodes 113b. In other words, the step layers 19 do not need to be provided in the inner layer portion 13.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a first surface and a second surface opposite each other in a lamination direction, a third surface and a fourth surface opposite each other in a first direction orthogonal to the lamination direction, and a fifth surface and a sixth surface opposite each other in a second direction orthogonal to the lamination direction and the first direction; and
an outer electrode on the fifth surface of the multilayer body; wherein
the multilayer body includes an inner layer portion including an inner dielectric layer and an inner electrode laminated on the inner dielectric layer in the lamination direction, the inner electrode including an end portion located at the fifth surface; and
the outer electrode includes:
an inner base electrode layer on the inner layer portion at the fifth surface and connected to the inner electrode;
an inner glass layer on the inner base electrode layer and including a glass component;
a plating layer on the inner glass layer; and
a connecting portion penetrating through the inner glass layer and electrically connecting the inner base electrode layer to the plating layer.

2. The multilayer ceramic capacitor according to claim 1, wherein the connecting portion includes a same metal component as the plating layer.

3. The multilayer ceramic capacitor according to claim 1, wherein a main component of the plating layer is Ni.

4. The multilayer ceramic capacitor according to claim 1, further comprising an outer layer portion including an outer dielectric layer and on a side of the inner layer portion adjacent to the first surface; wherein
the outer electrode includes:
a glass layer on the outer dielectric layer and including a glass component;
an outer base electrode layer on the glass layer and connected to the inner base electrode layer; and
an outer glass layer on the outer base electrode layer and including a glass component.

5. The multilayer ceramic capacitor according to claim 4, wherein a thickness of the outer glass layer is less than a thickness of the inner glass layer.

6. The multilayer ceramic capacitor according to claim 1, further comprising a step layer in a same plane as the inner electrode.

7. The multilayer ceramic capacitor according to claim 1, wherein the outer electrode is also provided on the first surface, the second surface, the third surface, and the fourth surface of the multilayer body.

8. The multilayer ceramic capacitor according to claim 1, further comprising another outer electrode on the sixth surface of the multilayer body.

9. The multilayer ceramic capacitor according to claim 8, wherein the another electrode is also provided on the first surface, the second surface, the third surface, and the fourth surface of the multilayer body.

10. The multilayer ceramic capacitor according to claim 1, further comprising a surface plating layer covering the plating layer.

11. The multilayer ceramic capacitor according to claim 9, wherein an area of glass components included in the inner base electrode layer is less than or equal to about 20% of a total sum of areas of the glass components and metal components of the inner base electrode layer.

12. The multilayer ceramic capacitor according to claim 1, wherein a thickness of the inner glass layer is greater than or equal to about 0.2 μm and less than or equal to about 3.5 μm.

13. A multilayer ceramic capacitor comprising:
a multilayer body including a first surface and a second surface opposite each other in a lamination direction, a third surface and a fourth surface opposite each other in a first direction orthogonal to the lamination direction, and a fifth surface and a sixth surface opposite each other in a second direction orthogonal to the lamination direction and the first direction;
a first outer electrode on the fifth surface of the multilayer body;
a second outer electrode on the sixth surface of the multilayer body;
a third outer electrode on the third surface of the multilayer body; and
a fourth outer electrode on the fourth surface of the multilayer body; wherein
the multilayer body includes an inner layer portion including an inner dielectric layer and a first inner electrode and a second inner electrode extending across the inner dielectric layer in the lamination direction;
the first inner electrode includes two end portions respectively located at the fifth surface and the sixth surface;
the second inner electrode includes two end portions respectively located at the third surface and the fourth surface;
each of the first outer electrode and the second outer electrode includes:
a first inner base electrode layer on the inner layer portion and connected to the first inner electrode;
a first inner glass layer on the first inner base electrode layer and including a glass component;
a first plating layer on the first inner glass layer; and
a first connecting portion penetrating through the first inner glass layer and electrically connecting the first inner base electrode layer to the first plating layer.

14. The multilayer ceramic capacitor according to claim 13, wherein each of the third outer electrode and the fourth outer electrode includes:
a second inner base electrode layer on the inner layer portion and connected to the second inner electrode;
a second inner glass layer on the second inner base electrode layer and including a glass component;
a second plating layer on the second inner glass layer; and
a second connecting portion penetrating through the second inner glass layer and electrically connecting the second inner base electrode layer to the second plating layer.

15. The multilayer ceramic capacitor according to claim 13, wherein the first connecting portion includes a same metal component as the first plating layer.

16. The multilayer ceramic capacitor according to claim 13, wherein a main component of the first plating layer is Ni.

17. The multilayer ceramic capacitor according to claim 13, further comprising an outer layer portion including an outer dielectric layer and on a side of the inner layer portion adjacent to the first surface; wherein
the first outer electrode or the second outer electrode includes:
a glass layer on the outer dielectric layer and including a glass component;
an outer base electrode layer on the glass layer and connected to the first inner base electrode layer or the second inner base electrode layer; and
an outer glass layer on the outer base electrode layer and including a glass component.

18. The multilayer ceramic capacitor according to claim 17, wherein a thickness of the outer glass layer is less than a thickness of the inner glass layer.

19. The multilayer ceramic capacitor according to claim 13, further comprising a surface plating layer covering the first plating layer.

20. The multilayer ceramic capacitor according to claim 13, further comprising a first step layer provided in a same plane as the first inner electrode and a second step layer provided in a same plane as the second inner electrode.
